(19) United States
(12) Patent Application Publication
(10) Pub. No.: US 2022/0222512 A1
(43) Pub. Date: Jul. 14, 2022

(54) SYSTEMS AND METHODS FOR COGNITIVE SIGNAL PROCESSING

(71) Applicant: The Boeing Company, Chicago, IL (US)

(72) Inventors: Gabriel L. Virbila, Venice, CA (US); Peter Petre, Oak Park, CA (US); Shankar R. Rao, Dunajska Luzna (SK)

(21) Appl. No.: 17/565,400

(22) Filed: Dec. 29, 2021

Related U.S. Application Data
(60) Provisional application No. 63/134,140, filed on Jan. 5, 2021.

(51) Int. Cl. G06N 3/063; G06N 3/08; G06K 9/62; G06F 1/10

(52) U.S. Cl. CPC G06N 3/063; G06F 1/10; G06K 9/6257; G06N 3/08

(57) ABSTRACT

Implementations provide denoising a signal. A plurality of reservoir state values are produced based on the signal and the plurality of reservoir state values are collected into a historical record. A plurality of reservoir state value weights are calculated based at least in part on the historical record to produce a plurality of output values. The plurality of reservoir state value weights are computed over multiple clock cycles of a clock for the cognitive signal processor system. The plurality of output values are output. A more accurate representation of a next of set of output layer weights is thereby obtained.

### CROSS-REFERENCE TO RELATED APPLICATION

This application claims the benefit of and priority to U.S. Provisional Application No. 63/134,140, entitled “Systems and Methods for Cognitive Signal Processing”, filed Jan. 5, 2021, which is incorporated by reference herein in its entirety.

### BACKGROUND

Cognitive signal processing is being developed to predict the behavior of complex human/animal/machine systems using a behavioral variable expressed as a waveform or a time series associated with the complex system. Such systems can be implemented in many different applications, such as for processing for economic systems, education systems, transportation systems, etc.

When implementing a cognitive signal processor (CSP) on hardware, multiple clock cycles are needed for computations in order run the system at higher clock rates, resulting in the processing of more signal bandwidth. For example, state-of-the-art systems for detecting, localizing, and classifying source emitters from passive radio-frequency (RF) antennas over ultrawide bandwidth require high sampling rate analog-to-digital converters (ADC). Such high-rate ADCs are expensive and have significant power demands, and due to fundamental physical limits, are not capable of achieving the high sampling rate to capture ultrawide bandwidth with an effective number of bits. To mitigate this, conventional approaches use electronic support measures (ESM) that either use spectrum sweeping (which is too slow to handle agile emitters) or a suite of digital channelizers, which have large size, weight, and power requirements. Additionally, the detection, localization and classification algorithm used in conventional ESM systems are typically based on the Fast Fourier Transform (FFT), with high computational complexity and memory requirements that make it difficult to operate these systems in real-time over an ultrawide bandwidth.

Denoising is used to improve the performance of these systems. Conventional methods for denoising include filter-based methods, and training-based approach. Filter-based methods employ filters to smooth out noise from signal, but are too simplistic to maintain both the low-frequency long-term trends of a signal and be able to adapt to the high-frequency abrupt transitions. Training-based methods rely on a “dictionary” that models the signal of interest. Such a dictionary must be trained in an offline process, and can require training data that is not available. Dictionaries also require a large amount of memory and computation to be stored and leverage on the platform, making it infeasible for ultra-low Size Weight and Power (SWaP) systems.

### SUMMARY

The disclosed examples are described in detail below with reference to the accompanying drawing figures listed below. The following summary is provided to illustrate examples or implementations disclosed herein. It is not meant, however, to limit all examples to any particular configuration or sequence of operations.

Some implementations provide a method of denoising a signal by a cognitive signal processor system that comprises producing a plurality of reservoir state values based on the signal and collecting the plurality of reservoir state values into a historical record. The method further comprises computing a plurality of reservoir state value weights based at least in part on the historical record to produce a plurality of output values. The plurality of reservoir state value weights are computed over multiple clock cycles of a clock for the cognitive signal processor system. The method also includes outputting the plurality of output values.

Other technical features may be readily apparent to one skilled in the art from the following figures, descriptions, and claims.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a diagram illustrating a reservoir computer mapping an input signal vector to a high-dimensional state-space.

FIG. 2 is a dynamic reservoir according to an implementation of the present disclosure.

FIG. 3 is a chart depicting an approximation of an input signal that is uniformly sampled.

FIG. 4 is a chart depicting an approximation of an input signal using Linear basis functions for approximating the input signal.

FIG. 5 is block diagram of a cognitive signal processor architecture that uses global feedback of the output signal according to an implementation of the present disclosure.

FIG. 6 is a schematic block diagram of a pipelined cognitive signal processor for denoising wide bandwidth signals according to an implementation of the present disclosure.

FIG. 7 is a schematic block diagram of a cognitive signal processor architecture optimized for minimum prediction length (MPL), showing propagation of delays through the system according to an implementation of the present disclosure.

FIG. 8 is a schematic block diagram of a cognitive signal processor architecture optimized for minimum multiplier utilization (MMU), showing propagation of delays through the system according to an implementation of the present disclosure.

FIG. 9 illustrates signal de-noising results for various implementations of the present disclosure.

FIG. 10 illustrates signal de-noising results for various implementations of the present disclosure.

FIG. 11 illustrates signal de-noising results for various implementations of the present disclosure.

FIG. 12 is a flowchart illustrating a method for denoising according to an implementation of the present disclosure.

FIG. 13 is a block diagram illustrating an operating environment showing an implementation of a system for performing cold spray additive manufacturing with gas recovery in accordance with an implementation.

Corresponding reference characters indicate corresponding parts throughout the drawings in accordance with an implementation.

### DETAILED DESCRIPTION

The foregoing summary, as well as the following detailed description of certain embodiments and implementations will be better understood when read in conjunction with the appended drawings. As used herein, an element or step recited in the singular and preceded by the word “a” or “an” should be understood as not necessarily excluding the plural of the elements or steps. Further, references to “one embodiment” or “one implementation” are not intended to be interpreted as excluding the existence of additional embodiments or implementations that also incorporate the recited features. Moreover, unless explicitly stated to the contrary, embodiments “comprising” or “having” an element or a plurality of elements having a particular property can include additional elements not having that property.

Certain implementations of the present disclosure provide a CSP configured to denoise, in real-time, an input signal containing a mixture of waveforms over a very large bandwidth (e.g., ultra-wide bandwidth). The CSP is implemented in various examples on either a field-programmable gate array (FPGA) or digital complementary metal-oxide-semiconductor (CMOS) hardware. With a CSP of the present disclosure, large computations do not have to be computed in one clock cycle. As a result, the maximum rate at which signals and ultimately the bandwidth that can be processed are increased. In this manner, when a processor is programmed to perform the operations described herein, the processor is used in an unconventional way, and allows for the more efficient signal processing and denoising.

A technical effect of implementations (e.g. computer program products) herein include increasing denoising performance while maintaining processing bandwidth (e.g., operating a higher clock rates).

In one implementation, the CSP is configured to allow for multiple clock cycle delays in computing various sets of values throughout the system using pipelining, resulting in a system running at a faster clock rate than conventional hardware CSPs. For example, as described in more detail herein, output layer weights do not have to be assumed to be updated within one clock cycle, instead allowing for updating the output layer weights in multiple clock cycles, resulting in increased achievable processing performance. That is, the present disclosure, through the conversion of the output layer weights described by ordinary differential equations (ODE) to delay differential equations (DDE), allows for the output layer weights to be updated over multiple clock cycles.

When implementing a CSP on hardware, multiple clock cycles are needed for computations in order run the system at higher clock rates resulting in the processing of more signal bandwidth. In operation, various examples described herein allow for multiple clock cycle delays in updating the next set of output layer weights with the conversion from an ODE to DDE used to describe the update equation. By using a DDE to describe the output layer weight update equation, a more accurate representation of the next of set of output layer weights is obtained. When the amount of delay required to update the next set of output layer weights is correctly accounted for by the system, computing the final output through the multiplication of the output layer weights with the history of state results in an increase in denoising performance, while maintaining processing bandwidth. For example, improved performance can be realized in swap receivers and other systems on airborne platforms. In one example, a CSP configured according to one or more examples of the present disclosure has expanded situational awareness, providing the core functionality required for ultra-low latency signal detection and analysis over large instantaneous bandwidth, which enables real-time resource allocation based on the RF environment. This type of performance can be achieved on computing platforms with orders of magnitude lower size, weight, and power. For example, the CSP is applicable to vehicle (e.g., UAV, plane, car, boat, robot) or man-portable applications, such as rapid detection and separation of significant objects (e.g., obstacles, terrain, other vehicles, persons, animals) from clutter from radar antenna signals. As a non-limiting example, once the denoised waveform signal is generated, the sought-after or otherwise identified object can be located using imagery, triangulation, or any other suitable technique, with assets then being deployed to the object's location. Such deployment can include causing an autonomous drone to physically maneuver above the object's location for surveillance purposes, etc.

As should be appreciated, the present disclosure can be implemented in various other different applications and on different platforms. For example, a CSP configured according to one or more examples of the present disclosure can be implemented in motor vehicle applications to enable cognitive radio in low SNR conditions. As another example, in autonomous vehicle operation, cars or other vehicles may use radars to detect and avoid obstacles. Due to clutter, such as trees, other cars, and walls, the radar returns for obstacles may be weak relative to other returns within the spectrum and also obscured by the obstacles. In one or more implementations described herein, the CSP can be used to denoise radio frequency (RF) signals, such as those collected by radar receivers (e.g., antenna, sensors, etc.). Separation of significant object pulses from clutter pulses reduces the likelihood that the autonomous vehicle is confused by clutter and can then effectively detect and avoid a significant object. For example, once a significant object is detected based on the denoised signal, the system can cause a vehicle to act (by being connected to an interfacing with an appropriate vehicle control system) based on the significant object, such as slowing, accelerating, stopping, turning, and/or otherwise maneuvering around the significant object. Other actions based on the obstacle are also possible, such as causing the vehicle to inform or warn a vehicle occupant and/or vehicle operator about the obstacle with an audible warning, a light, text, and/or an image, such as a radar display image. As further examples, the system can generate commands and control operations of vehicle systems that can be adjusted, such as vehicle suspension or safety systems such as airbags and seatbelts, etc. Yet another example application includes being used in vehicle manufacturing by helping to significantly denoise the control signal used for automated welding in the factory.

As described in more detail herein, one or more implementations use a reservoir computer to perform wideband signal denoising. In one example, a block diagonal structure of design reservoir connectivity matrix performs a number of multiplications that scale linearly with the number of reservoir nodes, and is thus more efficient to implement in low SWaP hardware. As should be appreciated, increasing the size of the system, such as increasing the number of states in the reservoir, enables improved performance, but would require that more computations be completed within one clock cycle. Slowing down the clock rate would allow for the size of the system to increase, but would limit the processing bandwidth, which is impracticable for most high performance applications. The present disclosure allows for multiple clock cycle delays in computing system values. By allowing for computations to take place over multiple clock cycles, the size of system is not limited by the number of computations that can take place in one clock cycle. This also allows for the CSP to be clocked at a higher rate due to system values being computed over multiple clock cycles with intermediate values being stored, resulting in higher processing bandwidth. Moreover, with the conversion from ODE to DDE used to describe the output layer update equation, a more accurate representation is obtained for the next set of weights that is computed over multiple clock cycles.

One implementation includes a CSP having delay-tolerant output layers for more efficient and effective signal de-noising, which can be implemented on an FPGA or ASIC chip. The CSP is configured as a system for parallelized cognitive signal denoising in some examples. The system in one example is a computer system operating software and in another example a “hard-coded” instruction set. The system can be incorporated into a wide variety of devices that provide different functionalities. In some examples, the system is configured for cognitive signal processing that takes an input signal containing a mixture of pulse waveforms over a very large (e.g., >30 GHz) bandwidth and denoises the input signal.

In this implementation, the CSP includes a reservoir computer (RC), which accepts mixture signals as input and maps the signals to a high-dimensional dynamical system known as the reservoir. The RC is a special form of recurrent neural network (i.e., a neural network having feedback connections between nodes), where the recurrent (feedback) connections are fixed and not adapted by the input signal, while the output layer connections are adapted by the input signal. The CSP is configured with a delay embedding. That is, the reservoir state signals are continuously passed through the delay embedding, which creates a finite temporal record of the values of the reservoir state, that models reservoir state dynamics. A short-time prediction module in one example adapts the output weights of the reservoir via gradient descent to produce a prediction of the input signal a small time-step in the future. Since the noise in the input signal is inherently random and unpredictable, the predicted input signal will be free of noise. The error between the predicted input signal and actual input is used by the weight adaptation module to further tune the output weights of the reservoir in an iterative process as described in more detail herein.

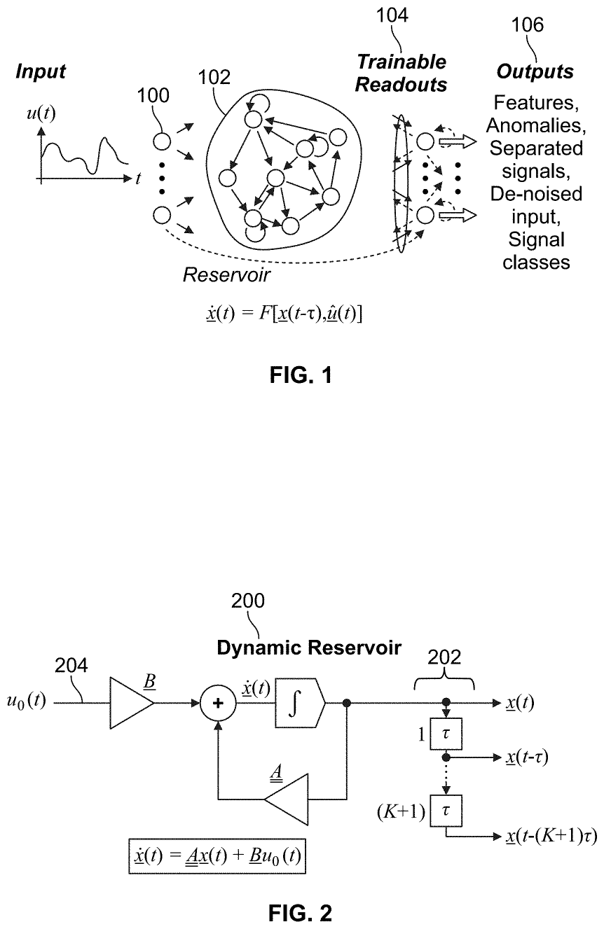

Thus, in one example, a cognitive signal denoising architecture is based on a form of “brain-inspired” signal processing known as RC. For example, as shown in FIG. 1, reservoir computing is a special form of a recurrent neural network (a neural network with feedback connections) that operates by projecting the input signal vector 100 into a high-dimensional reservoir state space 102 that contains an equivalent dynamical model of the signal generation process capturing all of the available and actionable information about the input. A reservoir has trainable readout layers 104 that can be trained, either off-line or on-line, to learn desired outputs by utilizing the state functions. The reservoir states can be mapped to useful outputs 106, including denoised inputs, signal classes, separated signals, and anomalies using the trainable linear readout layers 104. Thus, the RC has the power of recurrent neural networks to model non-stationary (time-varying) processes and phenomena, but with simple readout layers 104 and training algorithms that are both accurate and efficient.

In one example, a reservoir computer is implemented as an adaptable state-space filter. A linear reservoir computer has the following state-space representation in this example:

$$\dot{\underline{x}} ( t ) = {\underline{Ax}}_{-} ( t ) + \underline{B} u ( t )$$

$$y ( t ) = {\underline{C} ( t )}^{T} \underline{x} ( t ) + D ( t ) u ( t )$$

where A is the reservoir connectivity matrix that determines the filter pole locations, B is the vector mapping the input to the reservoir, C(t) is the set of tunable output layer weights that map the reservoir state to the output and determines the filter zero locations, and D (t) is the (rarely used) direct mapping from input to output. Similarly, the output layer weights (C) determine the filter zero locations. As the output layer weights are adaptable, a reservoir computer implements an adaptable state-space filter where the poles are fixed, but the zeros are adapted in real-time based on the input signal.

In conventional reservoir computers, the weights in both the reservoir connectivity matrix (A) and the input-to-reservoir mapping vector (B) are typically chosen randomly (e.g., entries of A and B can be independent, identically distributed samples from a zero-mean, unit variance Gaussian distribution). The reservoir state update require computation proportional to the square of the number of nodes, which become infeasible for low-power hardware instantiations as the number of reservoir node increases.

With the present disclosure, a reservoir state transition matrix A is used that is in block-diagonal form, where each block is of size 2×2. Thus, the computation of the reservoir state update requires computation that is linearly proportional to the number of the nodes. Each 2×2 block in the state matrix A corresponds to a single pole infinite impulse response (IIR) filter. Using IIR filter design techniques, the placement of the pole for each 2×2 block is selected so that the reservoir state matrix in aggregate models a bank of IIR filters. For example, for a real passive IIR filter, the matrix A must have eigenvalues that are either purely real and negative corresponding to purely damped modes, or eigenvalues that come in complex conjugate pairs, with negative real parts to the eigenvalues. Thus, the block-diagonal matrix A has the form:

$${A}_{⩵} = ( \begin{matrix}{λ}_{r , 1} & {λ}_{i , 1} & 0 & 0 & 0 & ⋯ & 0 & 0 \\ - {λ}_{i , 1} & {λ}_{r , 1} & 0 & 0 & 0 & ⋯ & 0 & 0 \\ 0 & 0 & {λ}_{r , 2} & {λ}_{i , 2} & 0 & ⋯ & 0 & 0 \\ 0 & 0 & - {λ}_{i , 2} & {λ}_{r , 2} & 0 & ⋯ & 0 & 0 \\ 0 & 0 & 0 & 0 & ⋱ & ⋱ & ⋮ & ⋮ \\ ⋮ & ⋮ & ⋮ & ⋮ & ⋱ & ⋱ & 0 & 0 \\ 0 & 0 & 0 & 0 & ⋯ & 0 & {λ}_{r , p} & {λ}_{i , p} \\ 0 & 0 & 0 & 0 & ⋯ & 0 & - {λ}_{i , p} & {λ}_{r , p}\end{matrix} )$$

where p is the number of complex conjugate poles, with N=2p, {λ_{r,k}}ₖ₌₁^{p} correspond the real components of the eigenvalues (that are always negative) of A and {±λ_{i,k}}ₖ₌₁^{p} are the imaginary components of the eigenvalues of A.

In one example, phase delay embedding is implemented to define a dynamic reservoir 200 as illustrated in FIG. 2. The dynamic reservoir 200 applies a delay embedding to the reservoir states to provide a time history of reservoir dynamics. More particularly, the dynamic reservoir 200 applies a delay embedding 202 to the reservoir states to provide a time history of reservoir dynamics. As shown, the delay embedding 202 is applied to each of the reservoir states instead of to an input signal 204. In this configuration, delays and adaptation are only required at the output of the reservoir, rather than at the input. Moreover, having a temporal record of the states provides more useful information for signal analysis than a temporal record of the raw signal input. Additionally, when combined with the designed reservoir states, delay-embedded states enable each state to be denoised separately, which can be used to generate a denoised spectrogram of the input signal.

In operation, the dynamic reservoir 200 with delay embedded inputs can be converted to an equivalent dynamic reservoir with delay-embedded states that is governed by the same dynamical system. The dynamic reservoir 200 applies a delay embedding to the reservoir states to provide a time history of reservoir dynamics. The phase delay embedding in various examples models the dynamics of a chaotic system from an observation u₀(t) using delayed versions of the observation as new input vector u(t). To use phase delay embedding theory, it is assumed that an unknown (potentially chaotic) dynamical system embedded in an N-dimensional state space has an m-dimensional attractor. This means that though the state space has N parameters, signals from the dynamical system form trajectories that all lie on an m-dimensional sub-manifold M of the state space, and can theoretically (though not practically) be specified by as few as m parameters.

The observations (received signal) u₀(t)=[\tilde{x}(t)] is a projection of the state space. The phase delay embedding produces a new input vector u(t) from n delayed versions of the observation signal u₁(t) concatenated together. According to Taken's theoremError! Reference source not found., given fairly broad assumptions on the curvature of the sub-manifold M and the nondegenerate nature of the projection h[⋅], if the number of delay coordinate dimensionality n>2m+1, then the phase delay embedding u(t) preserves the topological structure (i.e., shape) of the dynamical system, and thus can be used reconstruct the dynamical system from observations. It should be noted that the delay coordinate dimensionality can be increased more (but still not a function of the ambient dimensionality N) to be able to preserve both the topology and geometry of the dynamical system, without complete knowledge of the dynamical system or the observation function. With the present disclosure, the dynamic reservoir 200 is configured to apply the delay-embedding to each of the reservoir states to obtain a short-time history of the reservoir state dynamics.

In some examples, a short-term prediction method is used by the CSP for signal denoising. Given that delay-embedded observations can effectively model dynamical system behavior, the present disclosure leverages the time history of these reservoir state variables to perform short-term predictions of the observations. In one example, the CSP uses a reservoir computer to learn the prediction function F:

ũₒ(t+τ)=F[u₀(t)]

In this example of the CSP, a wideband (e.g., up to 30 GHz) frontend provides input to the dynamic reservoir. The weights of the output layers are adapted via a gradient learning algorithm as described below. The gradient descent learning algorithm is based on short-time prediction of the input signal, seeking to represent the output as a linear combination of historical reservoir state. Since noise is random and unpredictable, the predicted signal y(t) [symbol] uₒ(t+τ) will be free of noise.

In one implementation, the dynamic reservoir 200 in FIG. 2 satisfies the following set of coupled ordinary differential equations (ODE):

$$y ( t ) = {\sum }_{k = 1}^{K + 1} {{\underline{c}}_{k} ( t )}^{T} \underline{x} ( t - ( k - 1 ) τ ) + {\underline{d} ( t )}^{T} \underline{u} ( t ) ,$$

where u(t) [symbol] [u₀(t), u₀(t−τ), . . . , u₀(t−Kτ)]^{T}.

To perform short-time prediction of the input signal, the CSP uses an online gradient descent algorithm to enforce exact prediction of the current time point that is used in the delay embedding. The predicted input value at time (t+τ) is calculated from the current value the of the output weights (cₖ(t), d(t)) and the current and past values of the states (x) and the input (u). The quadratic error function to be minimized is given by:

$$E [ {\underline{c}}_{1} , … , {\underline{c}}_{K + 1} , \underline{d} ] \dot{=} {[ {u}_{0} ( t ) - \tilde{y} ( t - τ ) ]}^{2} + {λ}_{c} {\sum }_{k = 1}^{K + 1} {‖ {\underline{c}}_{k} ( t ) ‖}^{2} + {λ}_{d} {‖ \underline{d} ( t ) ‖}^{2} ,$$

where λ_{c} and λ_{d} are parameters that weight the importance of the output weights {ck}ₖ₌₁^{K+1} and d, and

$$\tilde{y} ( t - τ ) = {\sum }_{k = 1}^{K + 1} {{\underline{c}}_{k} ( t )}^{T} \underline{x} ( t - k τ ) + {\underline{d} ( t )}^{T} \underline{u} ( t - τ ) .$$

It should be noted that \tilde{y}(t−τ) is the delayed output expressed by the delayed valued of x and u and the current values of the output weights {ck}ₖ₌₁^{K+1} and d, and thus in general \tilde{y}(t−τ)≠y(t−τ). However, this approximation is reasonable, and allows the CSP to not require storage of time histories of output weights, facilitating more efficient hardware implementation.

To minimize the quadratic error E[c₁, . . . , c_{K+1}, d], the gradients of E[c₁, . . . , c_{K+1}, d] with respect to {ck}ₖ₌₁^{K+1} and d are computed. Based on these gradients, the weight updates to {cₖ(t)}ₖ₌₁^{K+1} and d(t) satisfy the following ordinary differential equations (ODEs):

ċₖ(t)=−g_{c}cₖ(t)+μ_{c}\tilde{ε}(t)x(t−kτ), k=1,2, . . . ,K+1

\dot{d}(t)=−g_{d}d(t)+μ_{d}\tilde{ε}(t)u(t−τ),

where g_{c}=2λ_{d} and g_{d}=2λ_{d} is the “forgetting” rates with respect to {ck}ₖ₌₁^{K+1} and d, μ_{c} and μd are the learning rates with respect to {ck}ₖ₌₁^{K+1} and d, and \tilde{ε}(t) [symbol] u₀(t)−\tilde{y}(t−τ) is the error signal.

The ODEs for the dynamic reservoir 200 and the weight adaptation system are implemented directly in analog hardware in one example. In another example, to implement the above ODEs in software or efficient digital hardware (e.g., field-programmable gate arrays (FPGAs) or custom digital application-specific integrated circuits (ASICs)), the update equations area discretized.

In order to implement a CSP in software or digital hardware, the ODEs are converted to delay difference equations (DDEs). For a linear dynamical system with the state-space representation:

$$\dot{\underline{x}} ( t ) = {\underline{Ax}}_{-} ( t ) + \underline{B} u ( t )$$

$$y ( t ) = {\underline{C} ( t )}^{T} \underline{x} ( t ) + D ( t ) u ( t ) ,$$

given the discrete time-step size τ, the equivalent DDE is obtained that describes the exact same filter dynamics:

$$\underline{x} ( t ) = {e}^{\underline{\underline{A}} τ} \underline{x} ( t - τ ) + {\int }_{t - τ}^{t} {e}^{\underline{\underline{A}} ( t - s )} u ( s ) ds \cdot \underline{B}$$

$$y ( t ) = {\underline{C} ( t )}^{T} \underline{x} ( t ) + D ( t ) u ( t ) ,$$

This equivalent DDE shows that the current reservoir state x(t) is a function of the reservoir state at the previous time step x(t−τ) and the input signal u(t) over the interval [t−τ, t]. Since the entire continuous interval is not available in software or digital hardware, in the digital CSP, u(t) is approximated over the interval using linear basis functions. Given the sampling period Δt, u(t) a set of samples uᵢ [symbol] u(t−(i−1)Δt), 1≤i≤nₑ, is collected, where

$${n}_{e} = \frac{τ}{Δ t} + 1$$

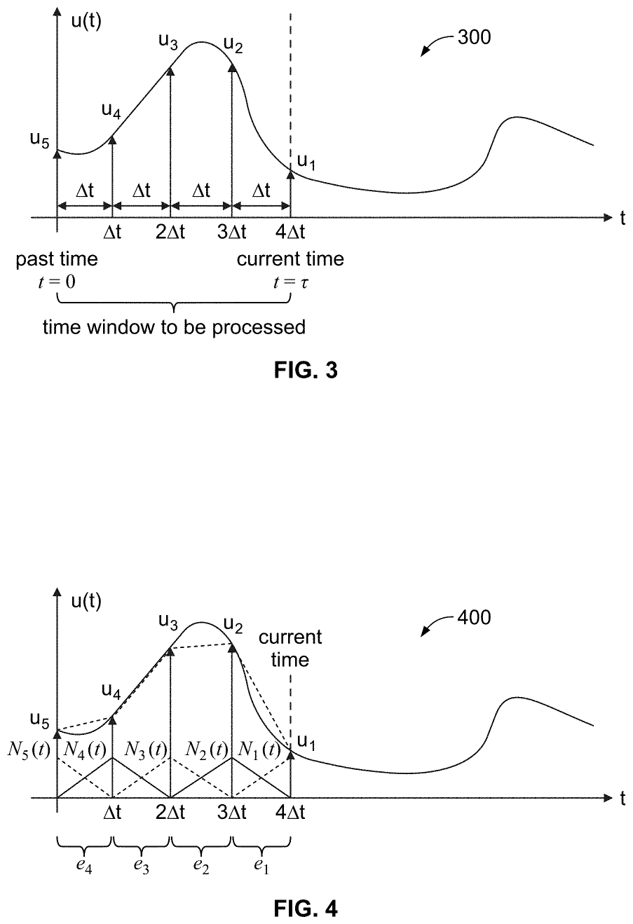

is one plus the number of sampling intervals within the time window defined by τ as seen in the graph 300 of FIG. 3. As seen in the graph 400 of FIG. 4, the input signal is approximated from the samples as u(t)≈Σᵢ₌₁ⁿ^{ₑ}uᵢ(t), where Nᵢ(t)=T(t−(i−t)Δt) is a shifted version of the triangle function T(t):

$$T ( t ) = \{ \begin{matrix}1 - t / Δ t & 0 \leq t \leq Δ t \\ 1 + t / Δ t & - Δ t \leq t \leq 0 \\ 0 & otherwise\end{matrix}$$

Thus, FIGS. 3 and 4 illustrate an approximation of a the input signal u(t) using uniform sampling and linear basis function. The graph 300 illustrates a uniformly sampled u(t) with sampling period Δt and the graph 400 illustrates Linear basis functions for approximating u(t).

Based on the linear basis approximation, the DDE for the reservoir state x(t) becomes:

$$\underline{x} ( t ) = {e}^{{A }_{=} t} \underline{x} ( t - τ ) + {\sum }_{i = 1}^{{n}_{e}} \{ {u}_{i} {\int }_{t - τ}^{t} {e}^{{A}_{=} ( t - s )} {N}_{i} ( s ) ds \cdot \underline{B} \}$$

Without loss of generality, t is set to equal τ (i.e., t=τ.) If the two auxiliary matrices B₁ₑⁱ and B₂ₑⁱ are defined as:

$${B}_{1 e}^{i} {=}^{def} {e}^{{A}_{=} ( i - 1 ) Δ t} {\int }_{0}^{τ} {e}^{{A}_{=} ( τ - s )} {N}_{1} ( s ) ds \cdot \underline{B} = \frac{{e}^{{A}_{=} ( i + 1 ) Δ t}}{Δ t} {{A}_{=}}^{- 2} ( {e}^{{A}_{=} Δ t} - Δ t {A}_{=} - I ) \underline{B}$$

$${B}_{2 e}^{i} {=}^{def} {e}^{{A}_{=} ( i - 1 ) Δ t} {\int }_{0}^{τ} {e}^{{A}_{=} ( τ - s )} {N}_{2} ( s ) ds \cdot \underline{B} \\ = {e}^{{A}_{=} ( i - 1 ) Δ t} \{ {{A}_{=}}^{- 1} ( {e}^{{A}_{=} Δ t} - 1 ) - \frac{1}{Δ t} {{A}_{=}}^{- 2} ( {e}^{{A}_{=} Δ t} - Δ t {A}_{=} - 1 ) \} \underline{B} ,$$

then x(τ) can be computed as:

$$\underline{x} ( τ ) = \underline{x} ( ( {n}_{e} - 1 ) Δ t ) = \underbrace{{e}^{{A}_{=} τ}}_{{A}_{s}} x ( 0 ) + {[ {\underline{B}}_{1 e}^{1} , ( {\underline{B}}_{2 e}^{1} + {\underline{B}}_{1 e}^{2} ) , … , ( {\underline{B}}_{2 e}^{{n}_{e} - 2} + {\underline{B}}_{1 e}^{{n}_{e} - 1} ) , {\underline{B}}_{2 e}^{{n}_{e} - 1}}_{{︶}_{{B}_{s}}} \underbrace{] [ \begin{matrix}{u}_{1} \\ {u}_{2} \\ ⋮ \\ {u}_{{n}_{e} - 1} \\ {u}_{{n}_{e}}\end{matrix} ]}_{\underline{u} ( τ )}$$

Based on the above, the iterative updates for the state (x), output (y) a, and weights ({cₖ}ₖ₋₁^{K+1},d), as derived, are represented in the following algorithm, which is a CSP de-noising algorithm with one-step lookahead:

Initialization:

$$\underline{x} [ 0 ] = \underline{0} , \underline{\underline{C}} [ 0 ] = \underline{0}$$

Iteration (starting at n=1):

$$\underline{x} [ n ] = {A}_{= S} \underline{x} [ n - 1 ] + {B}_{= S} [ \begin{matrix}u [ n ] \\ u [ n - 1 ]\end{matrix} ] \\ {X}_{=} [ n ] = [ \underline{x} [ x ] , \underline{x} [ n - 1 ] , … , \underline{x} [ n - K ] ] \\ {R}_{=} [ n ] = {C}_{=} [ n - 1 ] ⊗ {X}_{=} [ n - 1 ] \\ \tilde{ɛ} [ n ] = u [ n - 1 ] - y [ n - 1 ] \\ {C}_{=} [ n ] = ( {I}_{=} - Δ {tg}_{c} ) {C}_{=} [ n - 1 ] + Δ t {\tilde{μ}}_{c} \tilde{ɛ} [ n - 1 ] {X}_{=} [ n - {N}_{{τ}_{SK}} - {N}_{{τ}_{SN}} - 3 ] \\ \tilde{\underline{x}} [ n ] = {\sum }_{( columns )}^{ } {R}_{=} [ n - {N}_{{τ}_{SK}} ] \\ y [ n ] = {\sum }_{( rows )}^{ } \tilde{\underline{x}} [ n - {N}_{{τ}_{SN}} ] \qquad Algorithm 1$$

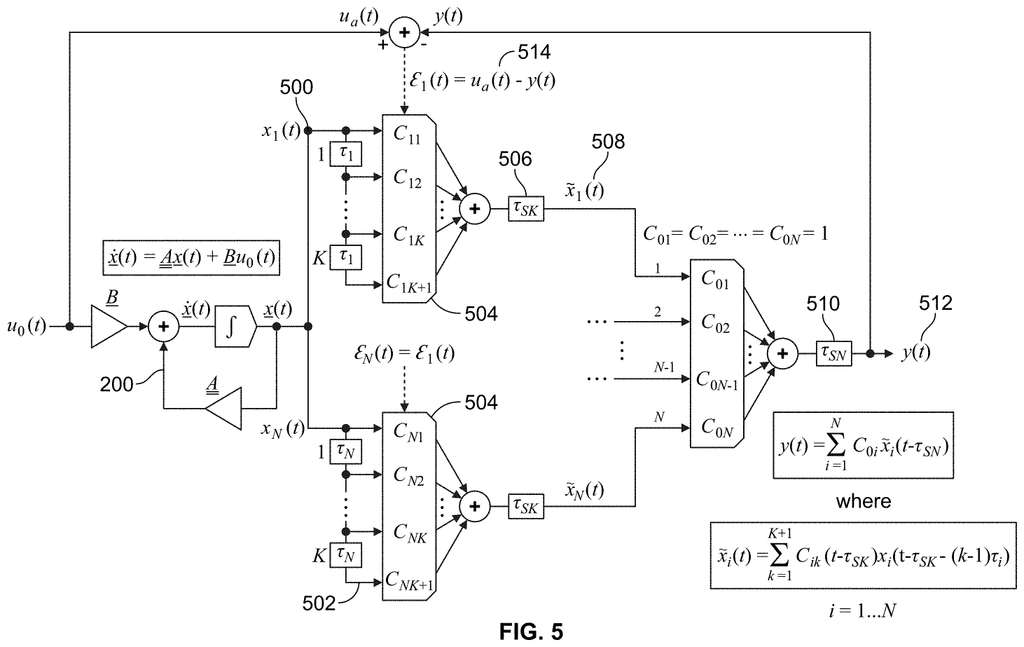

Each update step is achieved within one clock cycle without waiting for a calculation step to be completed before a subsequent step can start. This enables a parallelized implementation of the de-noising algorithm. The architecture for a system implementing the above iteration is shown in FIG. 5 and is capable of being implemented on a single FPGA or custom digital ASIC chip.

Specifically, FIG. 5 illustrates an implementation of a cognitive signal denoising architecture that de-noises an input signal u₀(t) to produce an output signal y(t). The input signal u₀(t) is sent into the dynamic reservoir 200. At each time step, the dynamic reservoir state x(t) is the sum of the previous reservoir state multiplied by the transition matrix A and the input signal multiplied by the input-to-reservoir mapping matrix B. The reservoir state vector x(t) is then split into individual elements 500 x₁(t), . . . , x_{N}(t), and for each reservoir state element 500 xᵢ(t), a time history of its dynamics is created by applying a length-K delay embedding. The delay embedded reservoir state elements 502 xᵢ(t), xᵢ(t−τᵢ), . . . , xᵢ(t−τᵢ) are multiplied by tunable output weights 504 Cᵢ₁, . . . , Cᵢ(K+1), summed together and delayed by time delay 506 τ_{SK} to obtain denoised reservoir state element 508 xᵢ₍ₜ₎. The denoised reservoir state elements are then summed together, and delayed by time delay 510 τ_{SN} to obtain the denoised output signal 512 y(t). Alternatively, a weighted sum can be applied via the fixed coefficients C₀₁, . . . , C_{0(K+1)} to the de-noised reservoir state elements. The error signal 514 ε(t) is constructed by subtracting the input signal 204 u₍ₜ₎ from the output signal 512 y(t), and this error signal is used to update the output weights 504. In one implementation, the same error signal is used to update each set of output weights. In another implementation, the error signals are varied for each reservoir state element (e.g., based on the different delay sizes τᵢ).

With reference now specifically to Algorithm 1, Aₛ is an m×m matrix specifying the set of mixing weights that govern the reservoir dynamics, Bₛ is an m×2 weight matrix that maps the input into the reservoir. \tilde{ε}[n] computes the error signal between the input and output. C[n] is the next set of output layer weights computed from the current set of output layer weights multiplied by a coefficient and summed with error signal multiplied with the stored history states of the reservoir. The next output, y[n], is computed by summing across the element wise multiplication of the output layer weights multiplied with their respective stored history value of the reservoir state. The number of set of output layers weights is equal to K, also known as the delay-embedding factor.

An example of a CSP with pipelining according to one implementation of the present disclosure will now be described. The CSP can impose limitations on the maximum clock rate and/or size of the reservoir, as all values are required to be computed and updated within one clock cycle. In any physical system, a finite amount of time is required to compute and update values throughout the hardware implemented cognitive signal processor. Better denoising performance is achieved through increasing the number of nodes or equivalently the Ã matrix in the reservoir, but at the cost of requiring more time to compute values whose number of required computations directly increase with the size of the reservoir. For example, in order to compute the output, y[n], the element wise multiplication of the output layer weights with the stored history of values of the reservoir state must be summed across all the products. By doubling the size of the reservoir, the number of products that must be summed within one clock cycle is doubled which requires more time compute the final value. Conversely, to process more instantaneous bandwidth, the clock rate must be increased to satisfy the Nyquist sampling criteria. But increasing the clock rate leaves less time for system values to computed and updated within one clock cycle, leaving the maximum clock rate dependent on size of the of the system.

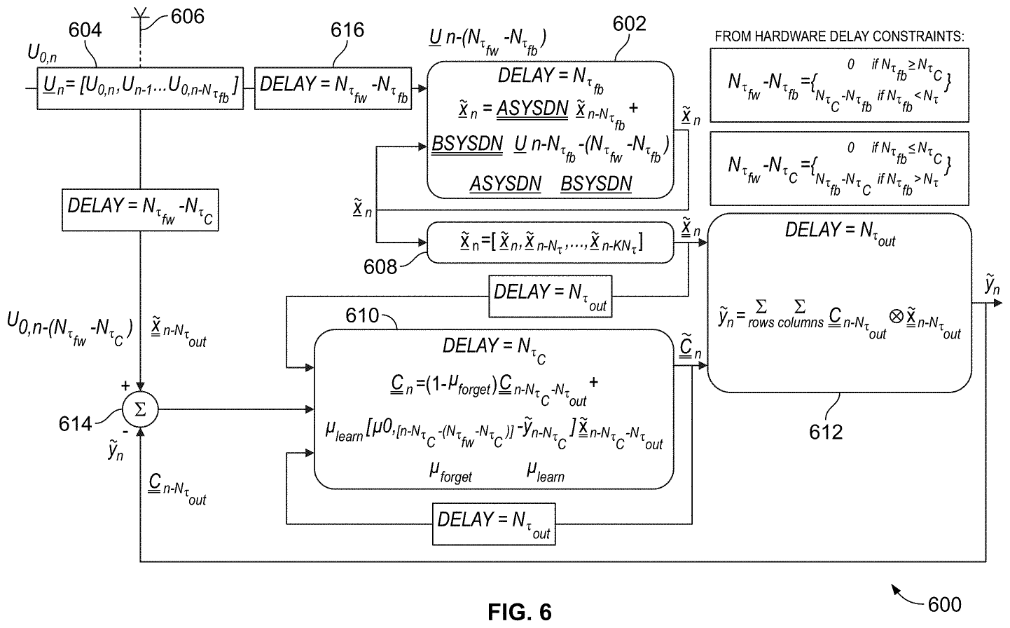

To compensate for the above discussed limitations, the CSP 600 as shown in FIG. 6 is provided. That is, the CSP 600 is a pipelined cognitive signal processor for denoising wide bandwidth signals. The CSP 600 includes a reservoir computer 602, which is the brain-inspired aspect of the signal denoising system. In general, a “reservoir computer” is a special form of a recurrent neural network (a neural network with feedback connections) that operates by projecting the input signal vector into a high-dimensional reservoir state space, which contains an equivalent dynamical model of the signal generation process capturing all of the available and actionable information about the input. The reservoir has readout layers that can be adapted, either off-line or on-line, to learn desired outputs by utilizing the state functions. Thus, the reservoir computer 602 has the power of recurrent neural networks to model non-stationary (time-varying) processes and phenomena, but with simple readout layers and adaptation algorithms that are both accurate and efficient.

As implemented in the CSP 600, the reservoir computer 602 accepts a mixture of wide-bandwidth signals 604 acquired by an antenna 606 and pre-processed into digital data as input, where each u_{i,j} represents measured values, that are mapped to a high-dimensional dynamical reservoir. It should be noted that as used herein, single underline terms represent vectors, and double underlined terms represent matrices. The reservoir computer 602 in various examples has a predefined number of outputs, which are generated by continually mapping the reservoir states through a set of distinct linear functions with one such function defined per output. Further, the reservoir computer 602 utilizes a block diagonal structure for its reservoir connectivity matrix denoted ASYSDN, which models feedback connections between nodes. The block diagonal structure facilitates a number of multiplications that scale linearly with the number of reservoir nodes, and is thus far more efficient to implement in low Size, Weight and Power (SWaP) hardware than similar signal denoising systems.

The reservoir computer 602 further uses a feed forward connection matrix denoted BSYSDN, which models feed forward connections from the inputs to the reservoir states. The reservoir computer 602 outputs the current states of its reservoir at time n, denoted BSYSDN, both to delay a delay embedding component 608 and as feedback data to itself. Thus, the current states output by the reservoir computer 602 are functions of its past states. It should be noted that processing by the reservoir computer 602 takes N_{τNB} to complete for each iteration.

The reservoir states {\tilde{x}}ₙ at time n from reservoir computer 602 are continuously passed through the delay embedding component 608, which creates a finite temporal record {\tilde{x}}ₙ of the values of the reservoir state, K+1 such states, with a delay of τ between the states. Thus, the delay embedding component 608 includes a volatile memory device, e.g., Random Access Memory (RAM), that holds states, and concatenates them into {\tilde{x}}ₙ. Each time a new {\tilde{x}}ₙ is received from the reservoir computer 602, it is added to the matrix {\tilde{x}}ₙ. Because the memory device is finite, once the memory device reaches capacity, the memory device drops the oldest Thus, the memory device utilizes first-in-first-out (FIFO) functionality with respect to incoming {\tilde{x}}ₙ in some examples. The delay embedding component 608 passes at least a portion of the historical records or reservoir states, X=˜n−N·τ out, to an weight adaptation component 610 and to an output layer computer 612.

In one example, the weight adaptation component 610 adapts the output of the reservoir computer 602 via gradient descent to produce a prediction of the input signal a small time step in the future. Noise is by definition random and therefore unpredictable, so the predicted input signal will be free of noise. The error between the predicted input signal and actual input is used by the weight adaptation component 610 to further tune the output weights of the reservoir in an iterative process, resulting in a clean or denoised output signal. Thus, the weight adaptation component 610 receives as inputs the finite temporal record {\tilde{x}}ₙ of the values of the reservoir states provided by the delay embedding component 608, as well as a difference provided by a comparator 614 between the input signal vector uₙ provided to the reservoir computer 602 and the ultimate output {\tilde{y}}ₙ by the output layer computer 612. The weight adaptation component 610 utilizes gradient descent based on this difference to scale the reservoir state matrix {\tilde{x}}ₙ. Further, the weight adaptation component 610 provides as an output a matrix of weights Cₙ to the output layer computer 612, and as feedback back to itself after being subjected to a delay of N_{T}_{ₒᵤₜ}. That is, the weight adaptation component 610 provides weights Cₙ that include the output layer, which are combined with the reservoir state matrix n to obtain the final output {\tilde{y}}ₙ.

The output layer computer 612, which applies the weights Cₙ determined by the weight adaptation component 610 to the reservoir states {\tilde{x}}ₙ, is determined by the reservoir computer. 602 The output layer computer 612 provides a denoised signal {\tilde{y}}ₙ, as an output for usage by a user or a component of a different system, such as a targeting system. The output layer computer 612 also provides the denoised signal {\tilde{y}}ₙ to the comparator 614 for comparison to the input signal vector uₙ.

It should be noted that the CSP 600 tracks and accounts for delays produced by the various components and processing. For example, the CSP 600 imposes a delay 616 to the input vector uₙ prior to input to the comparator 614. Thus, the data input to reservoir computer 602 may be characterized as (Nτfw−Nτfb).

Further, processing by the reservoir computer 602 introduces a delay of N_{τ}_{_{fb}}, processing by the weight adaptation component 610 introduces a delay of N_{τ}_{_{c}} and processing by the output layer computer 612 introduces a delay of N_{τ}_{ₒᵤₜ}. These are accounted for by introducing compensating delays elsewhere. For example, the feedback loop for the weight adaptation component 610 includes a delay of N_{τ}_{ₒᵤₜ}. User adjustable parameters include the input delay N_{τfw} and the prediction length, that is, how far ahead the prediction considers, N_{τ}_{ₒᵤₜ}. As a result of the delay accounting and other advantages described herein, throughput of various examples is typically at least an order of magnitude greater than from comparable techniques.

The CSP 600 may be advantageously implemented in hardware or firmware, as opposed to software implementation. Advantages include high speed (relative to software implementations), low weight, and low power requirements. Hardware implementations include, for example, implementations on Complementary Metal Oxide Semiconductor (CMOS), for example. Firmware implementations include implementations on Field Programmable Gate Arrays (FPGA), for example. Other hardware and firmware implementations are contemplated.

In contrast to existing cognitive signal processing systems in which all values are required to be computed and updated within one clock cycle and therefore impose limitations on the maximum clock rate and/or size of the reservoir, examples of the present disclosure have no such restrictions. Examples that are able to perform computations over a plurality of clock cycles have advantages over existing solutions. For any cognitive signal processor, a finite amount of time is required to compute and update values throughout the hardware. However, better denoising performance can be achieved by increasing the number of nodes, or equivalently increasing the size of reservoir connectivity matrix, but at the cost of requiring more time to compute values, where the number of required computations directly increase with the size of the reservoir. For example, in order to compute an output, the element wise multiplication of the output layer weights with the stored history of values of the reservoir state is summed across all the products. By doubling the size of the reservoir, the number of products that must be summed is doubled, which requires more time to compute the final value. Conversely, to process more instantaneous bandwidth, the clock rate must be increased to satisfy the Nyquist sampling criteria. But, increasing the clock rate leaves less time for system values to be computed and updated. For systems that must perform computations within one clock cycle, the maximum clock rate is highly dependent on the size of the system, e.g., as measured by the number of layers in the reservoir or equivalently the number of columns in the connectivity matrix.

Examples of the present disclosure compensate for these limitations by allowing and accounting for multiple clock cycles when computing various values throughout the system. Each major computation is broken down into a cascade of elementary functional computations over multiple clock cycles. In particular, the matrix multiplication and summing performed by the output layer computer 612, the state {\tilde{x}}ₙ update performed by the reservoir computer 602, and the output layer weight Cₙ update performed by the weight adaptation component 610 can each be performed over multiple clock cycles. Computing output {\tilde{y}}ₙ may utilize N_{τmul}x+log₄N+log₄ K clock cycles, where N N_{τmul} is a number of clock cycles used for elementwise pipeline multiplication, N is a size of the reservoir computer 602 (or number of rows to be summed), and K is a delay embedding factor (or number of columns to be summed). The logo reflects a pipeline summing tree, where four intermediate values are summed and then stored, to be used as an input in the next elementary summing computation. The four intermediate values for the logo summing tree correspond to values that are partial sums of the final summation from N inputs. For example, summing sixteen inputs using a logo summing tree would require log₄16=2 clock cycles. In this case, the first partial sums are represented as, for example:

sum₁=in₁+in₂+in₃+in₄,

sum₂=in₅+in₆+in₇+in₈,

sum₃=in₉+in₁₀+in₁₁+in₁₂,

sum₄=in₁₃+in₁₄+in₁₅+in₁₆,

with the final sum being represented as, by way of non-limiting example, sumₒᵤₜ=sum₁+sum₂+sum₃+sum₄. The computation of sumₒᵤₜ may occur over wₒ clock cycles. The first clock cycle is to compute the intermediate values, sum₁, sum₂, sum₃, and sum₄, and the second clock cycle is to compute the final output sumₒᵤₜ. According to some examples, all summations occur over multiple clock cycles and have intermediate values if the number of inputs is greater than the summing base. In this example, the summing base is four. However, examples are not limited to a base of four, and the base may depend in part, for example, on the selection of hardware for implementation.

Thus, in operation with the CSP 600, multiple clock cycles are allowed and accounted for when computing values throughout the system. Computation are broken down into a cascade of elementary functional computations. For the example of computing output yₙ, the number of clocks used is increased from 1 to N_{τmul}+Log₄N+Log₄K, where N_{τmul} is the number of clock cycles required to perform the element-wise pipeline multiplication, N is the size of the reservoir or number of rows that must be summed, and K is the delay-embedding factor or number of columns that must be summed. The log₄ implies a pipeline summing tree as described herein, where four intermediate values are summed and then stored, to be used as an input in the next elementary summing computation. Thus, the CSP 600 accounts for the delays required for particular size and operating frequency when computing various values throughout the system.

With the present disclosure, a delay-difference form of output layer adaptation is provided. In one example, a set of output layer weights C is determined that minimize the following objective function:

$$E \{ {C}_{=} \} = [ {u}_{0} ( t ) - y ( t ) ] + {λ}_{C} {‖ {C}_{=} ‖}_{F}^{2} \\ = [ {u}_{0} ( t ) - {\sum }_{( rows )}^{ } {\sum }_{( columns )}^{ } {C}_{=} ( t - {τ}_{p} ) ⊗ {X}_{=} ( t - {τ}_{p} ) ] \\ + {λ}_{C} {‖ {\sum }_{( rows )}^{ } {\sum }_{( columns )}^{ } {C}_{=} ( t ) ⊗ {C}_{=} ( t ) ‖}_{F}^{2} ,$$

where λ_{C} is a parameter that balances the importance of the signal prediction error versus the magnitude of the output layer weights.

Applying the gradient descent update

$$\underline{\underline{\dot{C}}} ( t ) = - μ {∇}_{\underline{\underline{C}}} E \{ \underline{\underline{C}} \}$$

with this objective function, the following is obtained:

$$\begin{matrix}\dot{{C}_{=}} ( t ) = - 2 {μλ}_{C} {C}_{=} ( t ) = 2 μɛ ( t ) {X}_{=} ( t - {τ}_{p} ) \\ = - {μ}_{forget} {C}_{=} ( t ) + {μ}_{learn} ɛ ( t ) {X}_{=} ( t - {τ}_{p} )\end{matrix}$$

Similar to the ODE for the reservoir state space system, this ODE is converted to a DDE as follows:

$${C}_{=} ( t ) = {e}^{- {μ}_{forget} {τ}_{fbC}} {C}_{=} ( t - {τ}_{fbC} ) + {μ}_{learn} {{\int }^{t}}_{t - {τ}_{fbC}} {e}^{- {{μ}_{forget}}^{( t - s )}} ɛ ( s ) {X}_{=} ( s - {τ}_{p} ) ds$$

The delay τ_{fbC} accounts for the entire feedback delay, including routing, registers in the feedback loops, delays in multipliers, and delays in the summing nodes. In addition to this feedback delay, the present disclosure accounts for the feedforward delay τ_{fwC} that is due to delays in multipliers and summing nodes in the second part (integration) of the update equation is also. This delay is compensated by using future values of the input up to u₀(t+τ_{fwC}) and selecting a prediction length τₚ. If the output delay τ_{C} is selected to be the maximum of the feedforward and feedback delays (i.e., τ_{C}=max (τ_{fbC}, τ_{fwC})), the following three coupled equations incorporating all the delays for updating the system states, output, and output layer weights are obtained:

$$\underline{x} ( t ) = {e}^{{A}_{=} {τ}_{x}} \underline{x} ( t - {τ}_{x} ) + {\int }_{t - τ}^{t} {e}^{{A}_{=} ( t - s )} {u}_{0} ( s ) ds \cdot \underline{B}$$

$$\tilde{y} ( t ) = y ( t - {τ}_{o u t} ) {\sum }_{( rows )}^{ } {\sum }_{( columns )}^{ } {C}_{=} ( t - {τ}_{out} ) ⊗ = {X}_{=} ( t - {τ}_{out} )$$

$${C}_{=} ( t ) = {e}^{- {μ}_{forget} {τ}_{C}} {C}_{=} ( t - {τ}_{C} ) + {μ}_{learn} {{\int }^{t}}_{t - {τ}_{C}} {e}^{- {μ}_{forget} ( t - s )} ɛ ( s ) {X}_{=} ( s - {τ}_{p} ) ds$$

Here, the delays τₓ, τₒᵤₜ, and τ_{C} are given by hardware constraints. The only delay value that is user-defined is the prediction length τₚ. The above equations model a real causal system only if τₚ≥τ_{C}+τₒᵤₜ. The total system delay (due to the input delay) is τ_{sys}=max(τₓ, τ_{C}). To convert this continuous time system to into a discrete time system that can be realized in an FPGA or digital CMOS hardware, the system of ODEs is decoupled into simultaneous scalar equations as follows:

$${C}_{i , j} ( t ) = {e}^{- {μ}_{forget} {τ}_{C}} {C}_{i , j} ( t - {τ}_{C} ) + {μ}_{learn} {\int }_{t - {τ}_{c}}^{t} {e}^{- {μ}_{forget} ( t - s )} ɛ ( s ) {X}_{i , j} ( s - {τ}_{p} ) d s .$$

The driving terms for the scalar ODEs as f(t) are then derived and the assumption made that the terms are independent from the current values of the weights.

f(t) [symbol] ε(t)X_{i,j}(t−τₚ)

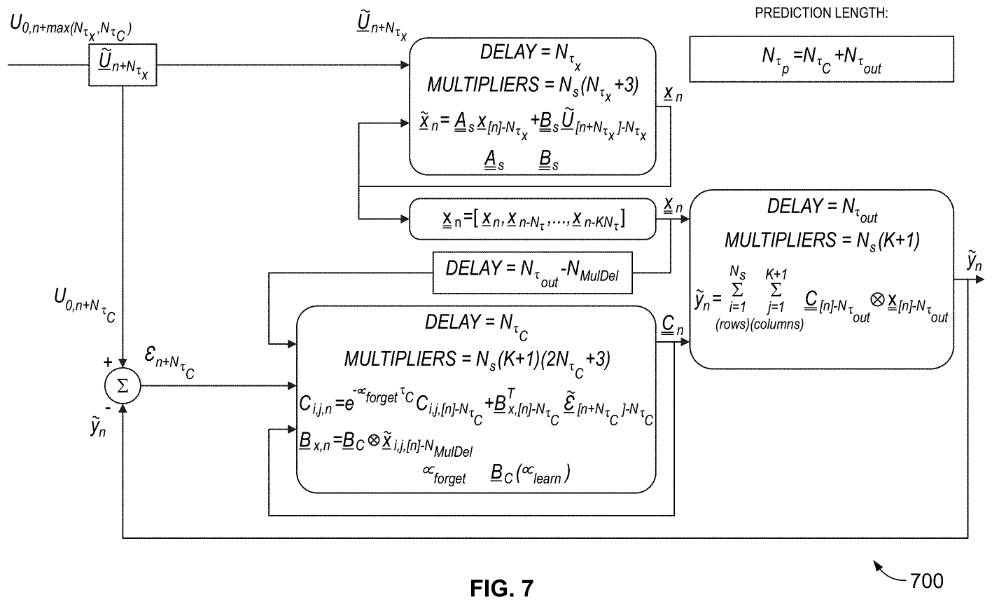

The CSP, namely the CSP architecture, in some examples is optimized for a minimum prediction length (MPL) as illustrated by an MPL CSP 700 shown in FIG. 7. That is, the minimum prediction length is provided enabling better de-noising performance, but also requires more hardware and computational resources than the “Minimum Number of Multipliers” CSP architecture as discussed below.

Using the time discretization process that was previously applied or the reservoir state update equation, the following is obtained:

$${C}_{i , j} [ n ] = {e}^{- {μ}_{forget} {τ}_{C}} {C}_{i , j} [ n - {N}_{{τ}_{C}} ] + {\underline{B}}_{C}^{T} [ \begin{matrix}f [ n ] \\ f [ n - 1 ] \\ ⋮ \\ f [ n - {N}_{{τ}_{C}} + 1 ] \\ f [ n - {N}_{{τ}_{C}} ]\end{matrix} ] , \\ where$$

$$f [ n ] = ( u [ n ] - y [ n - {N}_{{τ}_{C}} ] ) {X}_{i , j} [ n - {N}_{{τ}_{out}} - {N}_{{τ}_{C}} ] , \\ {\underline{B}}_{C}^{T} = [ {B}_{C 1 e}^{1} , ( {B}_{C 2 e}^{1} + {B}_{C 1 e}^{2} ) , … , ( {B}_{C 2 e}^{{N}_{{τ}_{C}} - 1} + {B}_{C 1 e}^{{N}_{{τ}_{C}}} ) , {B}_{C 2 e}^{{N}_{{τ}_{C}}} ] , \\ {B}_{C 1 e}^{i} = {e}^{- {μ}_{forget} ( i - 1 ) Δ t} ( \frac{{μ}_{learn}}{Δ {t ( {μ}_{forget} )}^{2}} ( {e}^{- {μ}_{forget} Δ t} + Δ t {μ}_{forget} - 1 ) )$$

$${B}_{C 2 e}^{i} = {e}^{- {μ}_{forget} ( i - 1 ) Δ t} ( \frac{1 - {e}^{- {μ}_{forget} Δ t}}{{μ}_{forget}} - \frac{{μ}_{learn}}{Δ {t ( {μ}_{forget} )}^{2}} ( {e}^{- {μ}_{forget} Δ t} + Δ t {μ}_{forget} - 1 ) ) , \\ and {N}_{{τ}_{C}} = \frac{{τ}_{C}}{Δ t} .$$

With particular reference to FIG. 7, the MPL CSP 700 according to one example is shown and illustrates the propagation of delays through the system. Table 1 lists the delay and resource requirements for the MPL CSP 600 in this example. In FIG. 7 and Table 1, Nₛᵤₘ is the maximum number of inputs into a summing junction that can be executed in one clock cycle. N_{MulDel} is the number of clock delays needed to execute a multiplication. N_{τ}_{ₓ}, N_{τ}_{ₒᵤₜ}, and N_{τ}_{_{C}} are the number of sample intervals in τₓ, τₒᵤₜ, and τ_{C}, respectively.

TABLE 1

| | | Resources |
|---|---|---|
| Equation | Delay | (Multipliers) |
| x[n] = A_{S}x[n − N_{τ}_{ₓ}] + B_{S}ũ[n] | N_{τ}_{ₓ} ≥ N_{MulDel} + log_{N}_{ₛᵤₘ}(N_{τ}_{ₓ} + 3) | Nₛ(N_{τ}_{ₓ} + 3) |
| $\tilde{y} [ n ] = {\sum }_{( rows )} {\sum }_{( columns )} \underline{\underline{C}} [ n - {N}_{{τ}_{out}} ] ⊗ \underline{\underline{X}} [ n - {N}_{{τ}_{out}} ]$ | ${N}_{{τ}_{out}} \geq {N}_{MulDel} + {log}_{{N}_{s u m}} {N}_{S} + {log}_{{N}_{s u m}} K + 1$ | Nₛ(K + 1) |
| C_{i,j}[n] = e^{-μ}^{_{forget}}^{τ}^{_{C}}C_{i,j}[n − N_{τ}_{_{C}}] + B_{C}^{T}\tilde{ε}[n] | N_{τ}_{_{C}} ≥ N_{MulDel} + log_{N}_{ₛᵤₘ}(N_{τ}_{_{C}} + 2) | Nₛ(K + 1) |
| | | (2N_{τ}_{_{C}} + 3) |

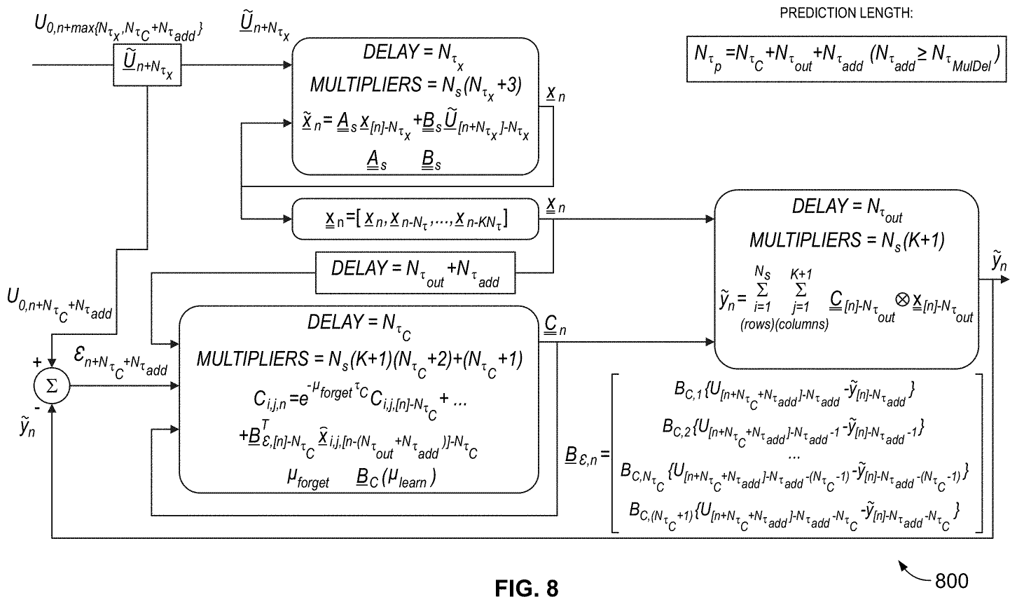

FIG. 8 shows an MPL CSP 800 according to one example and illustrating the propagation of delays through the system. Table 2 lists the delay and resource requirements for the MPL CSP 800 in this example, which is optimized for Minimum Multiplier Utilization (MMU). That is, in this example, the MPL CSP 800 is optimized for using the minimum number of multipliers by allowing longer prediction delay τₚ>τ_{C}+τₒᵤₜ. Specifically, the prediction length to be τₚ>τ_{c}+τₒᵤₜ+τ_{add}, where τ_{add}>0 is an additional amount tolerated delay in the system.

TABLE 2

| | | Resources |
|---|---|---|
| | | (Multipli- |
| Equation | Delay | ers) |
| x[n] = A_{S}x[n − N_{τ}_{ₓ}] + B_{S}ũ[n] | N_{τ}_{ₓ} ≥ N_{MulDel} + | Nₛ(N_{τ}_{ₓ} + |
| | log_{N}_{ₛᵤₘ}(N_{τ}_{ₓ} + 3) | 3) |
| $\tilde{y} [ n ] = {\sum }_{( rows )} {\sum }_{( columns )} \underline{\underline{C}} [ n - {N}_{{τ}_{out}} ] ⊗ \underline{\underline{X}} [ n - {N}_{{τ}_{out}} ]$ | N_{τ}_{ₒᵤₜ} ≥ N_{MulDel} + log_{N}_{ₛᵤₘ}N_{S}(K + 1) | Nₛ(K + 1) |
| $\begin{matrix}{C}_{i , j} [ n ] = {e}^{- {μ}_{forget} {τ}_{C}} {C}_{i , j} [ n - {N}_{{τ}_{C}} ] + \\ {\underline{B}}_{ɛ}^{T} [ n - {N}_{{τ}_{C}} ] {\underline{\hat{X}}}_{i , j} [ n - {N}_{{τ}_{C}} - {N}_{{τ}_{out}} - {N}_{{τ}_{add}} ] ,\end{matrix}$ | N_{τ}_{_{C}} ≥ N_{MulDel} + log_{N}_{ₛᵤₘ}(N_{τ}_{_{C}} + 2) | Nₛ(K + 1) (N_{τ}_{_{C}} + 2) + |
| | | (N_{τ}_{_{C}} + 1) |

In the MPL CSP 800, the number of multipliers needed for updating the output layer weights is minimized with the expense of additional delays. Using the time discretization process that was previously applied for the reservoir state update equation and the MPL CSP architecture, the following is obtained:

$${C}_{i , j} [ n ] = {e}^{- {μ}_{forget} {τ}_{C}} {C}_{i , j} [ n - {N}_{{τ}_{C}} ] + {\underline{B}}_{ɛ}^{T} [ n - {N}_{{τ}_{C}} ] {\hat{\underline{X}}}_{i , j} [ n - {N}_{{τ}_{C}} - {N}_{{τ}_{out}} - {N}_{{τ}_{add}} ] , \\ where$$

$${\underline{B}}_{ɛ}^{T} [ n ] = [ \begin{matrix}{B}_{C , 1} [ u [ n + {N}_{{τ}_{C}} ] - \tilde{y} [ n - {N}_{{τ}_{add}} ] \} \\ {B}_{C , 2} \{ u [ n + {N}_{{τ}_{C}} - 1 ] - \tilde{y} [ n - {N}_{{τ}_{add}} - 1 ] \} \\ {B}_{C , {N}_{{τ}_{C}}} \{ u [ n + 1 ] - \tilde{y} [ n - {N}_{{τ}_{add}} - ( {N}_{{τ}_{C}} - 1 ) ] \} \\ {B}_{C , {N}_{{τ}_{C}} + 1} \{ u [ n ] - \tilde{y} [ n - {N}_{{τ}_{add}} - {N}_{{τ}_{C}} ] \}\end{matrix} ] , \\ {\hat{\underline{X}}}_{i , j} [ n ] = [ \begin{matrix}{X}_{i , j} [ n ] \\ {X}_{i , j} [ n - 1 ] \\ ⋮ \\ {X}_{i , j} [ n - ( {N}_{{τ}_{C}} - 1 ) ] \\ {X}_{i , j} [ n - {N}_{{τ}_{C}} ]\end{matrix} ] .$$

The output layer weight update delay in this example is estimated as N_{τ}_{_{C}}≥N_{MulDel}+log_{N}_{ₛᵤₘ}(N_{τ}_{_{C}}+2). This value corresponds to a causal system capable of being realized in hardware only if N_{τ}_{_{add}}≥N_{MulDel}. The total system delay (due to input delay) is: τ_{sys}=max(τₓ,(τ_{C}+τ_{add})).

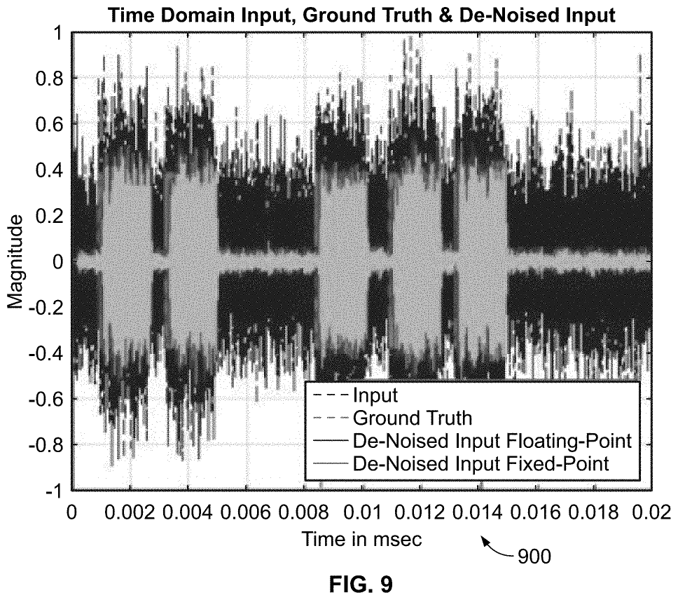

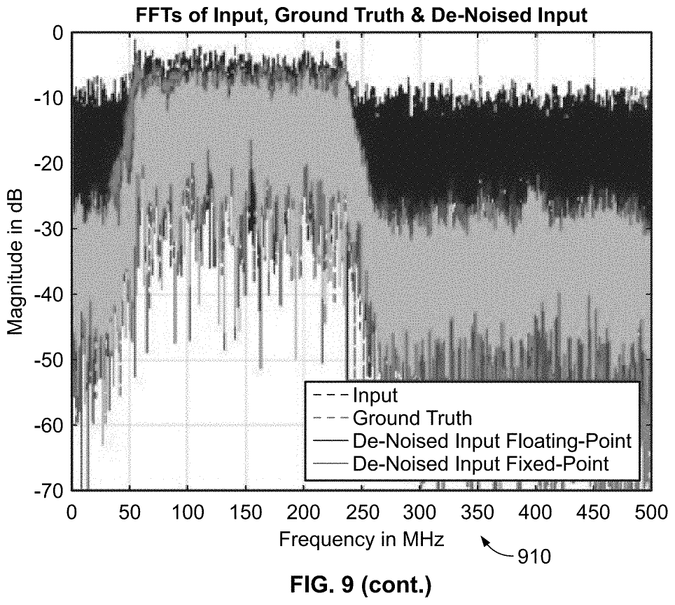

As illustrated in FIG. 9, the present disclosure performs signal de-noising of a synthetic input containing a mixture of pulses and noise. The illustrated input signal is a 20 microsecond length RF signal containing five linear chirp pulses in a 4 dB signal-to-noise ratio (SNR) environment. The de-noising performance of the present disclosure realized in MATLAB double-precision floating point and fixed-point software simulations are compared. Both the floating-point and fixed-point simulations use dynamic reservoirs with 80 nodes and length-26 delay embedding and uses the minimized prediction length de-noising architecture. The time-domain de-noising results are shown in graph 900, demonstrating that both the floating-point and fixed-point simulations are able to remove noise, being visually similar to the original ground truth pulse sequence. The frequency-domain de-noising results are shown in graph 910 and demonstrate that both floating-point and fixed-point simulations remove about 20 dB of noise from the input signal, with no appreciable difference in performance.

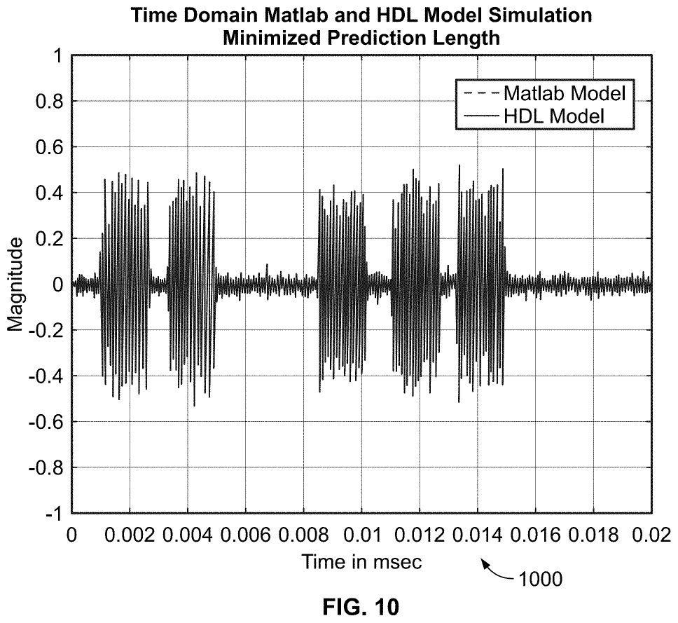

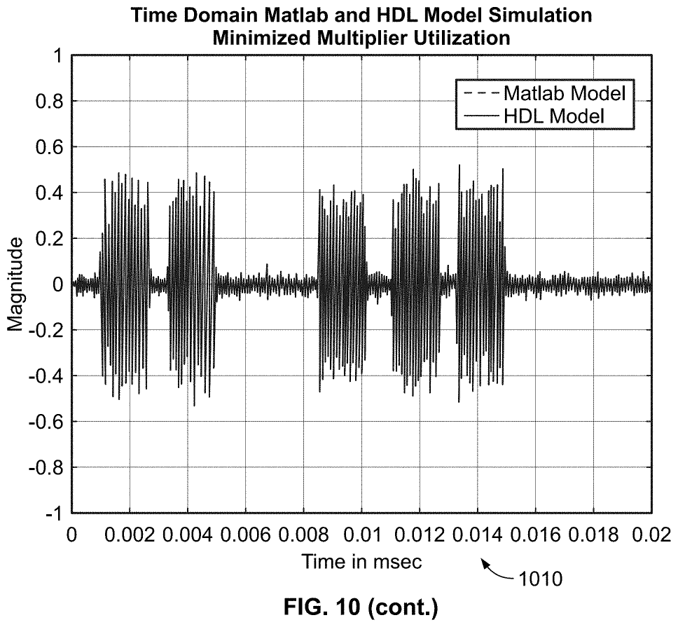

In FIG. 10, signal de-noising results in MATLAB fixed-point and HDL simulations of the present disclosure using MML and MMU architectures are compared. The input signal is the same 20-microsecond RF signal as in FIG. 9, containing five linear chirp pulses in a 4 dB SNR environment. All of the MATLAB HDL simulations of both architectures use dynamic reservoirs that have 80 nodes and length-26 delay embedding. As seen in graphs 1000 and 1010, the MATLAB and HDL simulations for each architecture match so closely that the MATLAB results are not visible behind the HDL results, because the MATLAB results are exactly equal (up to machine precision) to the HDL results. The HDL simulation results indicate that the present disclosure would obtain similar de-noising performance when realized in an FPGA.

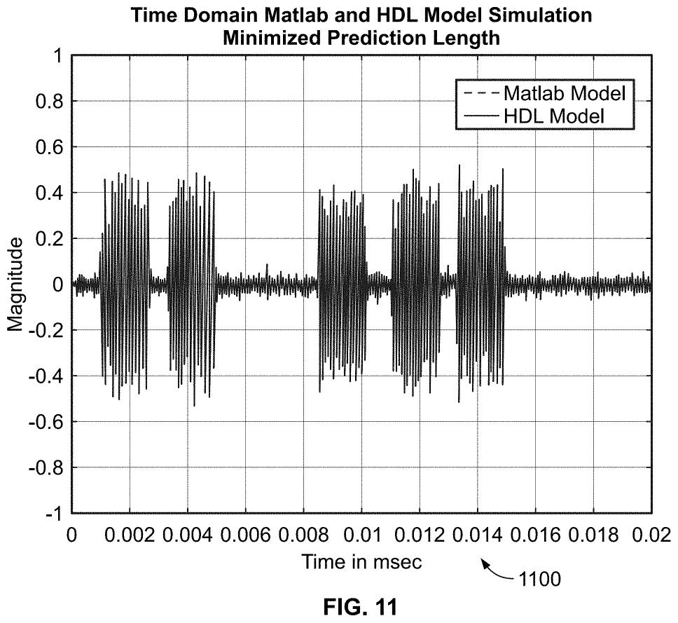

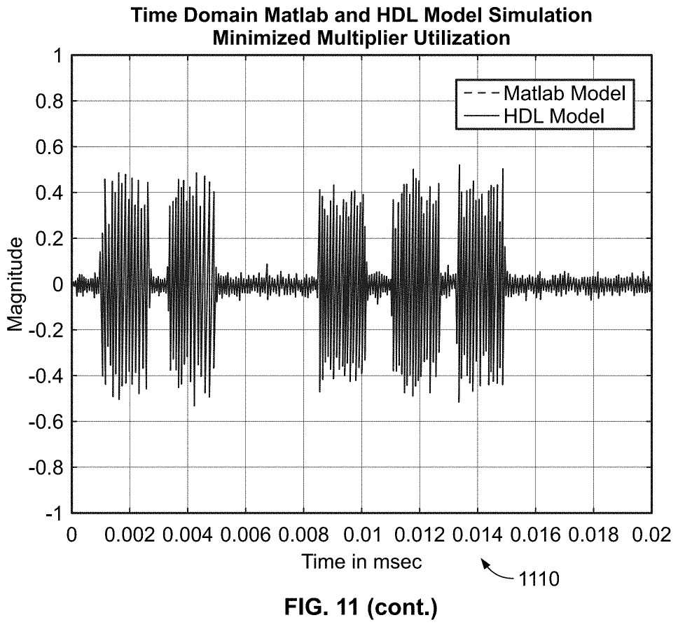

In FIG. 11, signal de-noising results realized in fixed-point HDL simulations of FPGA hardware using the MPL and MMU architectures are compared. The input signal is the same 20-microsecond RF signal as in FIG. 9, containing five linear chirp pulses in a 4 dB SNR environment. Both the MPL and MMU fixed-point simulations use dynamic reservoirs with 80 nodes and length-26 delay. As seen in the time-domain plots 1100 and the frequency-domain plots 1110, both the MPL and MMU architectures provide 20 dB of signal de-noising. The improvement in de-noising of the MPL architecture over the MMU architecture is not visually discernable, suggesting that in practical applications, the reduced computation of the MMU architecture can be leveraged without a significant reduction in de-noising performance.

Thus, various examples allow, for example, an ESM system to perform real-time processing of signals over an ultrawide bandwidth with expanded situational awareness, providing the core functionality for ultra-low latency signal detection and analysis over large instantaneous bandwidth. This enables real-time resource allocation based on the RF environment. With the present disclosure, output layer weight updates can occur over multiple clocks, such as when operating the CSP at higher clock rates. With the conversion from ODE to DDE that describes the output layer update equation, a more accurate representation is obtained for the next set of weights which is computed over multiple clock cycles. This more accurate representation for output layer weights results in better performance, while still operating at higher clock rates.

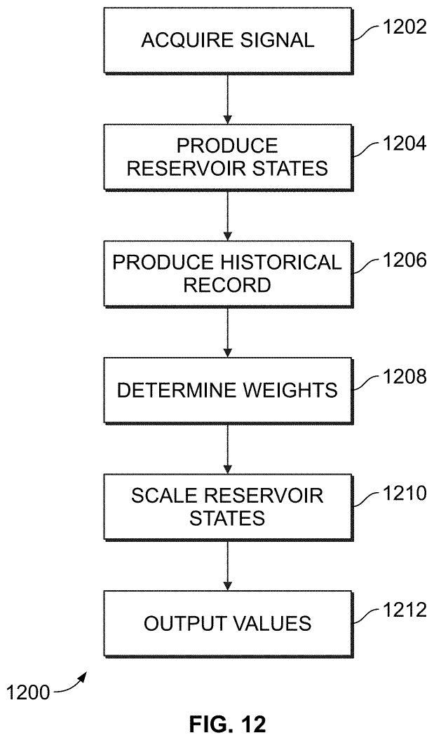

FIG. 12 is a flowchart illustrating a method 1200 for denoising wide bandwidth signals using pipelined cognitive signal processor according to various examples. The method 1200 can be implemented using CSP 600, 700, or 800. At 1202, the CSP acquires a signal using a single antenna (e.g., a single passive antenna). In some examples, the acquired signal is then digitized before being passed to the next stage in the process.

At 1204, the CSP produces reservoir states in the reservoir of the reservoir computer 602. The states are based on the mixture of wide-bandwidth signals provided to reservoir computer 302, as well as being based on feedback from the output of reservoir computer 602 itself.

At 1206, the delay embedding component 608 produces a historical record of reservoir states based on the individual reservoir states produced by the reservoir computer 602. At 1208, the weight adaptation component 610 determines weights (over multiple clock cycles) for the reservoir states as shown and described above in reference to FIG. 6. At 1210, the output layer computer 612 scales the reservoir states by the weights output from the weight adaptation component 610 as shown and described above in reference to FIG. 6. At 1214, the denoised signal is output according to the weighted reservoir states as determined by the output layer computer 612. The output may be made to any of a variety of systems and entities. According to some examples, the output is to a locating system, for example.

As should be appreciated, there are a number of applications in which examples can be implemented. For example, examples can be implemented in ESM receivers and within any other system in which it may be desirable to perform real-time processing of signals over an ultra-wide bandwidth. Examples provide expanded situational awareness, providing the core functionality required for ultra-low latency signal detection and analysis over large instantaneous bandwidth to enable real-time resource allocation based on the particular radio frequency environment. Without limitation, real-time resources includes further signal analysis assets and resources such as aircraft, drones, ships, and other vehicles, either collecting the noisy signals, or responding to the analysis of the denoised signals. This performance can be achieved on computing platforms with orders of magnitude lower size, weight, and power.

Examples are also applicable to vehicle applications, enabling cognitive radio in low signal-to-noise ratio conditions. Examples can also be used in vehicle manufacturing, helping to significantly denoise the control signal used for automated welding in the factory. The additional capability of examples to generate a real-time spectrogram will further facilitate situational awareness for airborne platforms and autonomous cars.

Examples are also applicable to vehicle (e.g., unmanned aerial vehicles—UAV, plane, car, boat, robot) or man-portable applications, such as rapid detection and separation of significant objects (e.g., obstacles, terrain, other vehicles, persons, animals) from clutter from radar antenna signals. As a non-limiting example, once the denoised waveform signal is generated, the sought-after or otherwise identified object can be located using imagery, triangulation, or any other suitable technique, with assets then being deployed to the object's location. Such deployment can include causing an autonomous drone to physically maneuver above the object's location for observation purposes, etc.

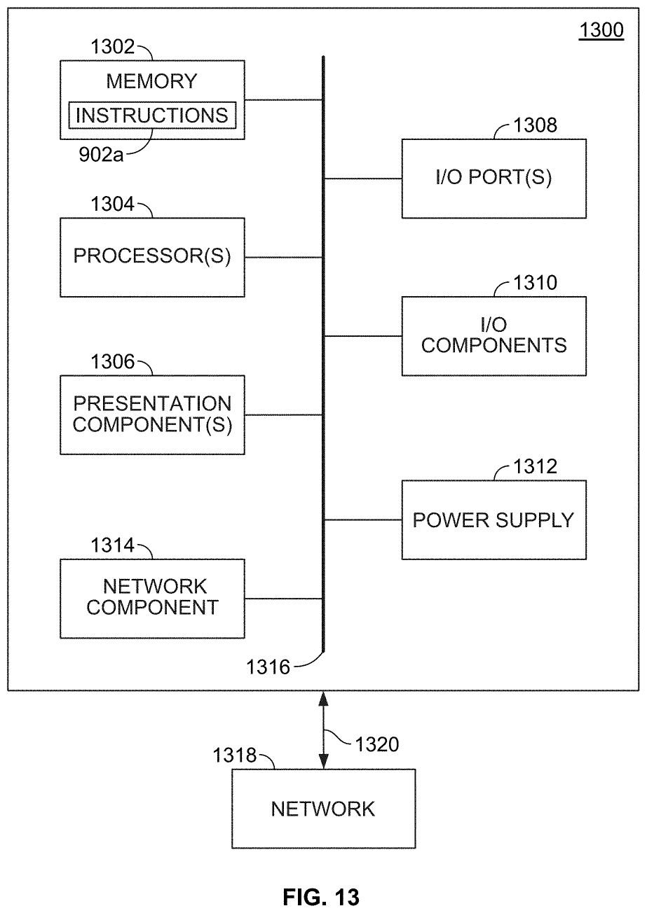

With reference now to FIG. 13, a block diagram of the computing device 1300 suitable for implementing various aspects of the disclosure is described. In some examples, the computing device 1300 includes one or more processors 1304, one or more presentation components 1306 and the memory 1302. The disclosed examples associated with the computing device 1300 are practiced by a variety of computing devices, including personal computers, laptops, smart phones, mobile tablets, hand-held devices, consumer electronics, specialty computing devices, etc. Distinction is not made between such categories as “workstation,” “server,” “laptop,” “hand-held device,” etc., as all are contemplated within the scope of FIG. 13 and the references herein to a “computing device.” The disclosed examples are also practiced in distributed computing environments, where tasks are performed by remote-processing devices that are linked through a communications network. Further, while the computing device 1300 is depicted as a seemingly single device, in one example, multiple computing devices work together and share the depicted device resources. For instance, in one example, the memory 1302 is distributed across multiple devices, the processor(s) 1304 provided are housed on different devices, and so on.

In one example, the memory 1302 includes any of the computer-readable media discussed herein. In one example, the memory 1302 is used to store and access instructions 1302a configured to carry out the various operations disclosed herein. In some examples, the memory 1302 includes computer storage media in the form of volatile and/or nonvolatile memory, removable or non-removable memory, data disks in virtual environments, or a combination thereof. In one example, the processor(s) 1304 includes any quantity of processing units that read data from various entities, such as the memory 1302 or input/output (I/O) components 1310. Specifically, the processor(s) 1304 are programmed to execute computer-executable instructions for implementing aspects of the disclosure. In one example, the instructions are performed by the processor, by multiple processors within the computing device 1300, or by a processor external to the computing device 1300. In some examples, the processor(s) 1304 are programmed to execute instructions such as those illustrated in the flow charts discussed below and depicted in the accompanying drawings.

The presentation component(s) 1306 present data indications to an operator or to another device. In one example, presentation components 1306 include a display device, speaker, printing component, vibrating component, etc. One skilled in the art will understand and appreciate that computer data is presented in a number of ways, such as visually in a graphical user interface (GUI), audibly through speakers, wirelessly between the computing device 1300, across a wired connection, or in other ways. In one example, presentation component(s) 1306 are not used when processes and operations are sufficiently automated that a need for human interaction is lessened or not needed. I/O ports 1308 allow the computing device 1300 to be logically coupled to other devices including the I/O components 1310, some of which is built in. Implementations of the I/O components 1310 include, for example but without limitation, a microphone, keyboard, mouse, joystick, game pad, satellite dish, scanner, printer, wireless device, etc.

The computing device 1300 includes a bus 1316 that directly or indirectly couples the following devices: the memory 1302, the one or more processors 904, the one or more presentation components 1306, the input/output (I/O) ports 1308, the I/O components 1310, a power supply 1312, and a network component 1314. The computing device 1300 should not be interpreted as having any dependency or requirement related to any single component or combination of components illustrated therein. The bus 1316 represents one or more busses (such as an address bus, data bus, or a combination thereof). Although the various blocks of FIG. 13 are shown with lines for the sake of clarity, some implementations blur functionality over various different components described herein.

In some examples, the computing device 1300 is communicatively coupled to a network 1318 using the network component 1314. In some examples, the network component 1314 includes a network interface card and/or computer-executable instructions (e.g., a driver) for operating the network interface card. In one example, communication between the computing device 1300 and other devices occur using any protocol or mechanism over a wired or wireless connection 1320. In some examples, the network component 1314 is operable to communicate data over public, private, or hybrid (public and private) using a transfer protocol, between devices wirelessly using short range communication technologies (e.g., near-field communication (NFC), Bluetooth® branded communications, or the like), or a combination thereof.

Although described in connection with the computing device 1300, examples of the disclosure are capable of implementation with numerous other general-purpose or special-purpose computing system environments, configurations, or devices. Implementations of well-known computing systems, environments, and/or configurations that are suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, VR devices, holographic device, and the like. Such systems or devices accept input from the user in any way, including from input devices such as a keyboard or pointing device, via gesture input, proximity input (such as by hovering), and/or via voice input.

Implementations of the disclosure are described in the general context of computer-executable instructions, such as program modules, executed by one or more computers or other devices in software, firmware, hardware, or a combination thereof. In one example, the computer-executable instructions are organized into one or more computer-executable components or modules. Generally, program modules include, but are not limited to, routines, programs, objects, components, and data structures that perform particular tasks or implement particular abstract data types. In one example, aspects of the disclosure are implemented with any number and organization of such components or modules. For example, aspects of the disclosure are not limited to the specific computer-executable instructions or the specific components or modules illustrated in the figures and described herein. Other examples of the disclosure include different computer-executable instructions or components having more or less functionality than illustrated and described herein. In implementations involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable, and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. In one example, computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium used to store information for access by a computing device. In contrast, communication media typically embody computer readable instructions, data structures, program modules, or the like in a modulated data signal such as a carrier wave or other transport mechanism and include any information delivery media.

The examples disclosed herein are described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples are practiced in a variety of system configurations, including personal computers, laptops, smart phones, mobile tablets, hand-held devices, consumer electronics, specialty computing devices, etc. The disclosed examples are also practiced in distributed computing environments, where tasks are performed by remote-processing devices that are linked through a communications network.

An example denoising cognitive signal processor system comprises: a reservoir computer; a delay embedding component; a weight adaptation component; and an output layer computer, wherein, an output of the reservoir computer is communicatively coupled to an input of the reservoir computer and to the delay embedding component, the reservoir computer being configured to produce a plurality of reservoir state values; an input of the delay embedding component communicatively coupled to an output of the reservoir computer and an output of the delay embedding component communicatively coupled to an input of the weight adaptation component and to an input of the output layer computer, the delay embedding component configured to collect the plurality of reservoir state values; an output of the weight adaptation component communicatively coupled to an input of the weight adaptation component and to an input of the output layer computer, the weight adaptation component configured to compute a plurality of reservoir state value weights to produce a plurality of output values, wherein the plurality of reservoir state value weights are computed over multiple clock cycles of a clock for the cognitive signal processor system; and an input of the output layer computer communicatively coupled to an output of the delay embedding component, an input of the output layer computer communicatively coupled to an output of the weight adaptation component, and an output of the output layer computer communicatively coupled to an input to the weight adaptation component, the output layer computer being configured to output the plurality of output values.

An example of a method of denoising a signal by a cognitive signal processor system comprises producing a plurality of reservoir state values based on the signal; collecting the plurality of reservoir state values into a historical record; computing a plurality of reservoir state value weights based at least in part on the historical record to produce a plurality of output values, wherein the plurality of reservoir state value weights are computed over multiple clock cycles of a clock for the cognitive signal processor system; and outputting the plurality of output values.

An example computer program product comprises a computer usable medium having a computer readable program code embodied therein, the computer readable program code adapted to be executed to implement a method of denoising a signal, the method comprises: producing a plurality of reservoir state values based on the signal; collecting the plurality of reservoir state values into a historical record; computing a plurality of reservoir state value weights based at least in part on the historical record to produce a plurality of output values, wherein the plurality of reservoir state value weights are computed over multiple clock cycles of a clock for the cognitive signal processor system; and outputting the plurality of output values.

Alternatively, or in addition to the other examples described herein, examples include any combination of the following:
wherein the plurality of reservoir state value weights define output layer weights that are updated over the multiple clock cycles by converting ordinary differential equations (ODE) of an output layer weight update equation to delay differential equations (DDE).
computing a representation for a next set of weights over the multiple clock cycles.
wherein the plurality of reservoir state value weights define output layer weights and further comprising computing a final output using multiplication of the output layer weights with a history of state results.
wherein an output delay is defined as a maximum of feedforward and feedback delays.
wherein the plurality of reservoir state value weights define output layer weights and further comprising minimizing the output layer weights using an objective function including a parameter that balances an importance of a signal prediction error versus a magnitude of the output layer weights.
wherein the output layer weights C are defined as:

$$\underline{\underline{C}} [ t ] = {e}^{- {μ}_{forget} {τ}_{C}} \underline{\underline{C}} ( t - {τ}_{C} ) + {μ}_{learn} {\int }_{t - {τ}_{C}}^{t} {e}^{- {μ}_{forget} ( t - s )} ɛ ( s ) \underline{\underline{X}} ( s - {τ}_{p} ) ds$$

wherein, the τₓ, τₒᵤₜ, and τ_{C} are delays based on hardware constraints.

When introducing elements of aspects of the disclosure or the implementations thereof, the articles “a,” “an,” “the,” and “said” are intended to mean that there are one or more of the elements. The terms “comprising,” “including,” and “having” are intended to be inclusive and mean that there could be additional elements other than the listed elements. The term “implementation” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A denoising cognitive signal processor system comprising:
a reservoir computer;
a delay embedding component;
a weight adaptation component; and
an output layer computer, wherein,
an output of the reservoir computer is communicatively coupled to an input of the reservoir computer and to the delay embedding component, the reservoir computer being configured to produce a plurality of reservoir state values;
an input of the delay embedding component communicatively coupled to an output of the reservoir computer and an output of the delay embedding component communicatively coupled to an input of the weight adaptation component and to an input of the output layer computer, the delay embedding component configured to collect the plurality of reservoir state values;
an output of the weight adaptation component communicatively coupled to an input of the weight adaptation component and to an input of the output layer computer, the weight adaptation component configured to compute a plurality of reservoir state value weights to produce a plurality of output values, wherein the plurality of reservoir state value weights are computed over multiple clock cycles of a clock for the denoising cognitive signal processor system; and
an input of the output layer computer communicatively coupled to an output of the delay embedding component, an input of the output layer computer communicatively coupled to an output of the weight adaptation component, and an output of the output layer computer communicatively coupled to an input to the weight adaptation component, the output layer computer being configured to output the plurality of output values.

2. The denoising cognitive signal processor system of claim 1, wherein the plurality of reservoir state value weights define output layer weights that are updated over the multiple clock cycles by converting ordinary differential equations (ODE) of an output layer weight update equation to delay differential equations (DDE).

3. The denoising cognitive signal processor system of claim 2, wherein a representation for a next set of weights is computed over the multiple clock cycles.

4. The denoising cognitive signal processor system of claim 1, wherein the plurality of reservoir state value weights define output layer weights and a final output is computed using multiplication of the output layer weights with a history of state results.

5. The denoising cognitive signal processor system of claim 1, wherein an output delay is defined as a maximum of feedforward and feedback delays.

6. The denoising cognitive signal processor system of claim 1, wherein the plurality of reservoir state value weights define output layer weights and the output layer weights are minimized using an objective function including a parameter that balances an importance of a signal prediction error versus a magnitude of the output layer weights.

7. The denoising cognitive signal processor system of claim 6, wherein the output layer weights C are defined as:
$${C}_{=} ( t ) = {e}^{- {μ}_{forget} {τ}_{C}} {C}_{=} ( t - {τ}_{C} ) + {μ}_{learn} {\int }_{t - {τ}_{C}}^{t} {e}^{- {μ}_{forget} ( t - s )} ɛ ( s ) {X}_{=} ( s - {τ}_{p} ) d s$$
wherein, the τₓ, τₒᵤₜ, and τ_{C} are delays based on hardware constraints.

8. A method of denoising a signal by a cognitive signal processor system, the method comprising:
producing a plurality of reservoir state values based on the signal;
collecting the plurality of reservoir state values into a historical record;
computing a plurality of reservoir state value weights based at least in part on the historical record to produce a plurality of output values, wherein the plurality of reservoir state value weights are computed over multiple clock cycles of a clock for the cognitive signal processor system; and
outputting the plurality of output values.

9. The method of claim 8, wherein the plurality of reservoir state value weights define output layer weights that are updated over the multiple clock cycles by converting ordinary differential equations (ODE) of an output layer weight update equation to delay differential equations (DDE).

10. The method of claim 9, further comprising computing a representation for a next set of weights over the multiple clock cycles.

11. The method of claim 8, wherein the plurality of reservoir state value weights define output layer weights and further comprising computing a final output using multiplication of the output layer weights with a history of state results.

12. The method of claim 8, wherein an output delay is defined as a maximum of feedforward and feedback delays.

13. The method of claim 8, wherein the plurality of reservoir state value weights define output layer weights and further comprising minimizing the output layer weights using an objective function including a parameter that balances an importance of a signal prediction error versus a magnitude of the output layer weights.

14. The method of claim 13, wherein the output layer weights C are defined as:
$${C}_{=} ( t ) = {e}^{- {μ}_{forget} {τ}_{C}} {C}_{=} ( t - {τ}_{C} ) + {μ}_{learn} {\int }_{t - {τ}_{C}}^{t} {e}^{- {μ}_{forget} ( t - s )} ɛ ( s ) {X}_{=} ( s - {τ}_{p} ) ds$$
wherein, the τₓ, τₒᵤₜ, and τ_{C} are delays based on hardware constraints.

15. A computer program product, comprising a computer usable medium having a computer readable program code embodied therein, the computer readable program code adapted to be executed to implement a method of denoising a signal, the method comprising:
producing a plurality of reservoir state values based on the signal;
collecting the plurality of reservoir state values into a historical record;
computing a plurality of reservoir state value weights based at least in part on the historical record to produce a plurality of output values, wherein the plurality of reservoir state value weights are computed over multiple clock cycles of a clock for a cognitive signal processor system; and
outputting the plurality of output values.

16. The computer program product of claim 15, wherein the plurality of reservoir state value weights define output layer weights that are updated over the multiple clock cycles by converting ordinary differential equations (ODE) of an output layer weight update equation to delay differential equations (DDE).

17. The computer program product of claim 16, wherein the method further comprises computing a representation for a next set of weights over the multiple clock cycles.

18. The computer program product of claim 15, wherein the plurality of reservoir state value weights define output layer weights and the method further comprises computing a final output using multiplication of the output layer weights with a history of state results.

19. The computer program product of claim 15, wherein the plurality of reservoir state value weights define output layer weights and the method further comprises minimizing the output layer weights using an objective function including a parameter that balances an importance of a signal prediction error versus a magnitude of the output layer weights.

20. The computer program product of claim 19, wherein the output layer weights C are defined as:
$${C}_{=} ( t ) = {e}^{- {μ}_{forget} {τ}_{C}} {C}_{=} ( t - {τ}_{C} ) + {μ}_{learn} {\int }_{t - {τ}_{C}}^{t} {e}^{- {μ}_{forget} ( t - s )} ɛ ( s ) {X}_{=} ( s - {τ}_{p} ) ds$$
wherein, the τₓ, τₒᵤₜ, and τ_{C} are delays based on hardware constraints.
